(19) United States
(12) Patent Application Publication
(10) Pub. No.: US 2024/0356291 A1
(43) Pub. Date: Oct. 24, 2024

(54) TRACK ADAPTER, TRACK, AND ELECTRICAL SYSTEM

(71) Applicants: SUZHOU OPPLE LIGHTING CO., LTD., Suzhou City (CN); OPPLE LIGHTING CO., LTD., Shanghai (CN)

(72) Inventor: Shuchao LI, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 18/759,904

(22) Filed: Jun. 30, 2024

Related U.S. Application Data
(63) Continuation of application No. PCT/CN2022/141532, filed on Dec. 23, 2022.

(30) Foreign Application Priority Data
Dec. 31, 2021 (CN) 202111675540.6
Dec. 31, 2021 (CN) 202123426655.X

(51) Int. Cl. H01R 25/14; H01R 13/506; H01R 13/62; H01R 13/627

(52) U.S. Cl. CPC H01R 25/142; H01R 13/506; H01R 13/6205; H01R 13/6273; H01R 25/145

(57) ABSTRACT

The present disclosure provides a track adapter, a track, and an electrical system. The track adapter is used to couple an electrical equipment to the track in a first direction, and includes a shell and a sliding assembly slidably connected to the shell, the sliding assembly includes a sliding side cover located at an end of the shell and an elastic assembly located within the shell and fixedly connected to the sliding side cover, the elastic assembly includes two symmetrically disposed elastic arms and elastic blocks located at an end of each of the elastic arms away from sliding side cover, a side wall of the shell is provided with elastic block sliding grooves at positions corresponding to the elastic blocks, and two guide ribs in cooperation with the elastic arms are further disposed within the shell.

### CROSS-REFERENCE TO RELATED APPLICATION(S)

This application is based upon and claims the priority of PCT patent application No. PCT/CN2022/141532 filed on Dec. 23, 2022 which claims priority to the Chinese patent application No. 202123426655.X filed on Dec. 31, 2021, and the Chinese patent application No. 202111675540.6 filed on Dec. 31, 2021, the entire contents of which are hereby incorporated by reference herein for all purposes.

### TECHNICAL FIELD

The present disclosure relates to the technical field of lighting technology, especially to a track adapter, track, and electrical system.

### BACKGROUND

Track lamps are mainly composed of a track (a conductive track) fixed on a ceiling or wall, and various lamps capable of sliding along the tracks, which can be spotlights, line lamps, or the like.

### SUMMARY OF THE INVENTION

The present disclosure provides a track adapter, a track, and an electrical system.

The present disclosure provides a track adapter that may be for coupling an electrical equipment to a track in a first direction. The track adapter may include: a shell and a sliding assembly slidably connected to the shell, the sliding assembly comprises a sliding side cover located at an end of the shell and an elastic assembly located inside the shell and fixedly connected to the sliding side cover, the elastic assembly comprises two symmetrically disposed elastic arms and elastic blocks located at an end of each of the elastic arms near the sliding side cover, a side wall of the shell is provided with elastic block sliding grooves at positions corresponding to the elastic blocks, two guide ribs in cooperation with the elastic arms are further disposed inside the shell, a giving-way channel for giving way to the elastic assembly is formed between the two guide ribs, and the elastic assembly cooperates with the guide ribs to drive the elastic blocks to slide out of or into the elastic block sliding grooves.

The present disclosure also provides a track that is connected in conjunction with the aforementioned track adapter. The track may be configured to be mechanically and electrically connected to the track adapter above; the track may be provided with an anti-detachment boss extending in the third direction, the anti-detachment boss is configured to support the elastic assembly and the snap part of the track adapter.

The present disclosure further provides an electrical system that may include the aforementioned track adapter. The electrical system may include a track and the track adapter above; the track is provided with an anti-detachment boss extending in the third direction, the track adapter comprises a sliding assembly, guide ribs, and a snap part, the sliding assembly comprises a sliding side cover and an elastic assembly, the sliding side cover drives the elastic assembly to cooperate with the guide ribs so that the elastic assembly is connected to or separated from the anti-detachment boss; the snap part is connected to or separated from the anti-detachment boss under an interaction between the snap part and an inner surface of the track; the inner surface of the track is provided with an conductive part extending in a length direction of the track, an outer surface of the track adapter is provided with a contact elastic piece, and the conductive part is electrically connected to the contact elastic piece.

It is to be understood that both the foregoing general description and the following detailed description are exemplary and explanatory only and are not restrictive of the present disclosure.

### BRIEF DESCRIPTION OF THE DRAWINGS

Hereinafter the technical solutions and other beneficial effects of the present disclosure will become apparent by illustrating the examples of the present disclosure in detail with reference to the accompanying drawings.

FIG. 1 is a three-dimensional view of a track adapter of a first example of the present disclosure.

FIG. 2 is a structural exploded view of FIG. 1.

FIG. 3 is a three-dimensional view of a portion of structure of the shell in FIG. 2.

FIG. 4 is a three-dimensional view of another portion of structure of the shell in FIG. 2.

FIG. 5 is a three-dimensional view of the elastic assembly in FIG. 2.

FIG. 6 is a three-dimensional view of the sliding side cover in FIG. 2.

FIG. 7 is a schematic view showing the releasing by pression of the track adapter in FIG. 1.

FIG. 8 is a top view corresponding to the status in FIG. 7 (with the top cover removed). FIG. 9 is an enlarged view of the circle portion in FIG. 7.

FIG. 10 is a three-dimensional view of a track of an example of the present disclosure.

FIG. 11 is a sectional view of an electrical system of an example of the present disclosure during installation.

FIG. 12 is a sectional view of the electrical system in FIG. 11 after the completion of installation.

FIG. 13 is a three-dimensional view of a track adapter of a second example of the present disclosure.

FIG. 14 is a structural exploded view of FIG. 13.

FIG. 15 is a three-dimensional view of the elastic assembly in FIG. 14.

FIG. 16 is a three-dimensional view of the elastic assembly in FIG. 15 viewing from another angle.

FIG. 17 is a three-dimensional view of a portion of structure of the shell in FIG. 13.

FIG. 18 is a three-dimensional view of another portion of structure of the shell in FIG. 13.

FIG. 19 is a schematic view showing the releasing by pression of the track adapter in FIG. 13.

FIG. 20 is a top view corresponding to the status in FIG. 19 (with the top cover removed).

### DETAILED DESCRIPTION

To make objects, technical solutions, and advantages of the disclosure clearer, the present disclosure will be described in detail with reference to the accompanying drawings and the examples.

Here, it is to be noted that to avoid obscuring the present disclosure with unnecessary details, only the structure and/or processing steps closely related to the solutions of the present disclosure are shown in the accompanying drawings, while other details less related to the present disclosure are omitted.

In addition, it is to be noted that the terms “comprise/comprising”, “include/including” or any other variations thereof are intended to cover non-exclusive inclusion, so that a process, method, article, or equipment including a series of elements comprises not only those elements, but also comprises other elements which are not explicitly listed, or elements which are inherent to such process, method, article, or equipment.

### Reference Signs in this disclosure may include:

100—track adapter, 110—shell, 111—top wall, 1111—leg, 1112—hook, 112—side wall, 1121—elastic block sliding groove, 11221—clamping opening, 113—bottom wall, 1131—fixing part, 1132—booster block, 114—installation space, 115—stop rib, 116—guide rib, 1161—first wall, 1162—second wall, 1163—arc wall, 117—guide gap, 118—guide protrusion, 120—sliding side cover, 121—press part, 122—sliding stop part, 1221—support plate, 1222—connection plate, 1223—receiving slot, 123—stop wall, 124—connection part, 1241—guide protrusion, 1242—guide gap, 130—elastic assembly, 131—elastic body, 132—elastic arm, 1321—first end, 1322—second end, 1323—third end, 133—elastic block, 1331—inclined plane, 134—installation part, 135—deformation point, 140—snap part, 141—fixed end, 142—free end, 143—stop projection, 1431—guiding slope, 1432—abutting slope, 150—contact elastic piece, 151—powder supply elastic piece, 152—signal elastic piece, 160—second magnetic piece, 170—sliding assembly, 200—track, 210—receiving space, 211—installation plate, 2111—installation hole, 212—receiving space, 213—assembly groove, 214—conductive groove, 220—first magnetic piece, 230—anti-detachment lug boss, 240—conductive part, 241—power supply conductive part, 242—signal conductive part, 250—insulation protective part, 300—electrical system.

Track adapters fitted with the tracks are usually hidden within the tracks, which increases the difficulty for installing the track lamps. In addition, most of current track lamps on the market are magnetic track lamps, in which the lamp body is directly connected to the track by magnetic force, which is convenient for rapidly installing. However, during the use of the track lamps, using magnetic connection alone does not have a strong stability. If the magnetic attraction between magnetic pieces disappears, or the light-emitting module is relatively heavy, the track adapter may be likely to be separated from the track, resulting in safety risk of track lamp falling.

In view of the above, there is a need to provide a track adapter, track, and electrical system to solve the above problems.

### Example 1

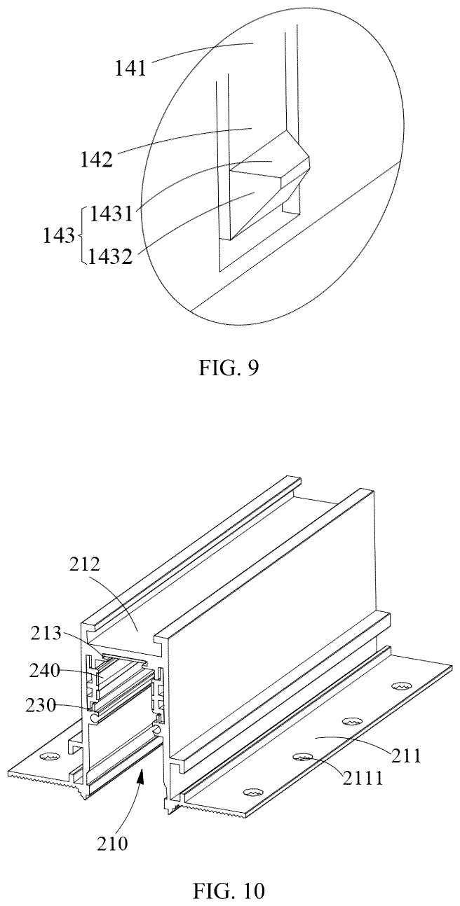

Referring to FIGS. 1 to 9 and with reference to FIGS. 10 to 12, a track adapter 100 of the first example of the present disclosure is shown, which is used to couple an electrical equipment (not shown) to a track 200 in a first direction. The track adapter 100 comprises a shell 110, a sliding side cover 120 and an elastic assembly 130. By the cooperation of the sliding side cover 120 with the elastic assembly 130, it is achieved to rapidly install the track adapter 100 coupled with the electrical equipment to the track 200, and increase the connection stability between the track adapter 100 and the track 200. When there is a need of disassembling the track adapter 100, the track adapter 100 can be rapidly disassembled from the track 200 by the cooperation of the sliding side cover 120 with the elastic assembly 130, which is convenient and quick, and can reduce the difficulty of installation and disassembly and increase the efficiency of installation and disassembly.

The sliding side cover 120 is slidably connected to an end of the shell 110 in a second direction perpendicular to the first direction. An elastic assembly 130 is fixedly connected inside the shell 110. The elastic assembly 130 comprises an elastic body 131 and two elastic blocks 133 disposed on two sides of the elastic body 131. A side wall 112 of the shell 110 is provided with two elastic block sliding grooves 1121 at positions corresponding to the two elastic blocks 133. The elastic assembly 130 cooperates with the sliding side cover 120, and is configured for being applied with a pushing force by the sliding side cover 120 in the second direction to drive the two elastic blocks 133 to move towards each other in a third direction, so as to slide out of the elastic block sliding grooves 1121, and move away from each other in the third direction to slide into the elastic block sliding grooves 1121 after the pushing force disappears, in which the third direction is perpendicular to both the first direction and the second direction. In other words, when the sliding side cover 120 is driven by a pushing force, the sliding side cover 120 applies a pushing force to the elastic assembly 130 in the second direction, causing the elastic assembly 130 to deform, so that the two elastic blocks 133 move towards each other in the third direction to slide out of the elastic block grooves 1121. At that time, the elastic blocks 133 are in retracted state, which is convenient to rapidly couple the track adapter 100 to the track 200, or disassemble the track adapter 100 from the track 200. When the pushing force disappears or is absent, the two elastic blocks 133 move away from each other in the third direction under the action of the elastic assembly 130's own elastic force to slide into the elastic block sliding grooves 1121. At that time, the elastic blocks 133 are in extended state, which is convenient to abut against the anti-detachment boss 230 on the track 200 extending in the third direction to increase the connection stability between the track 200 and the track adapter 100.

Optionally, the first direction is a height direction of the track 200 or the track adapter 100, the second direction is a length direction of the track 200 or the track adapter 100, and the third direction is a width direction of the track 200 or the track adapter 100. The first direction, the second direction, and the third direction are perpendicular to each other.

It can be known that the switching between the extended state and the retracted state of the elastic blocks 133 can be controlled manually or automatically via a control device. That is, the movement of the sliding side cover 120 towards the elastic assembly 130 in the second direction can controlled either manually or automatically, which is not specifically limited in the examples of the present disclosure.

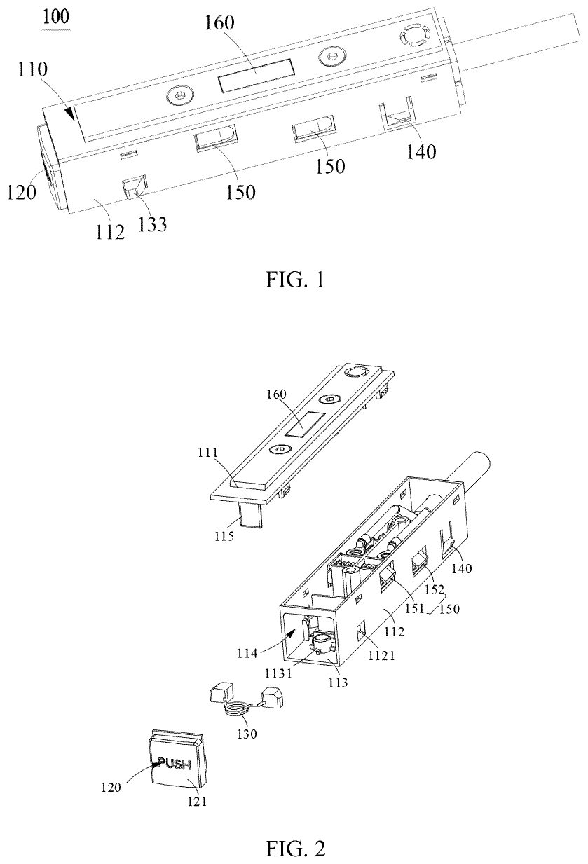

Referring to FIGS. 1 and 2, the shell 110 comprises a top wall 111 and a bottom wall 113 extending in the length direction, a pair of side walls 112 connecting the top wall 111 and the bottom wall 113 and extending in the length direction, and two opposite ends connecting the top wall 111 and the bottom wall 113 and extending in the width direction. The bottom wall 113, the side walls 112, and the ends surround to form a lower groove having an installation space 114 for receiving an electrical part, and the elastic assembly 130, etc.

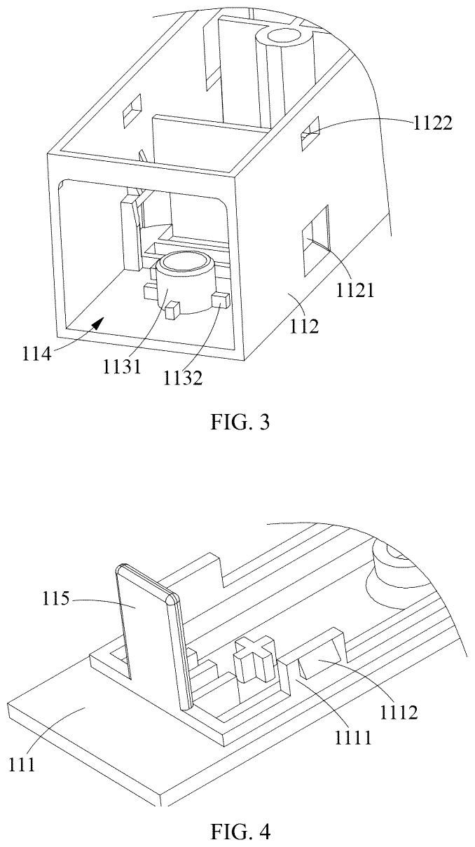

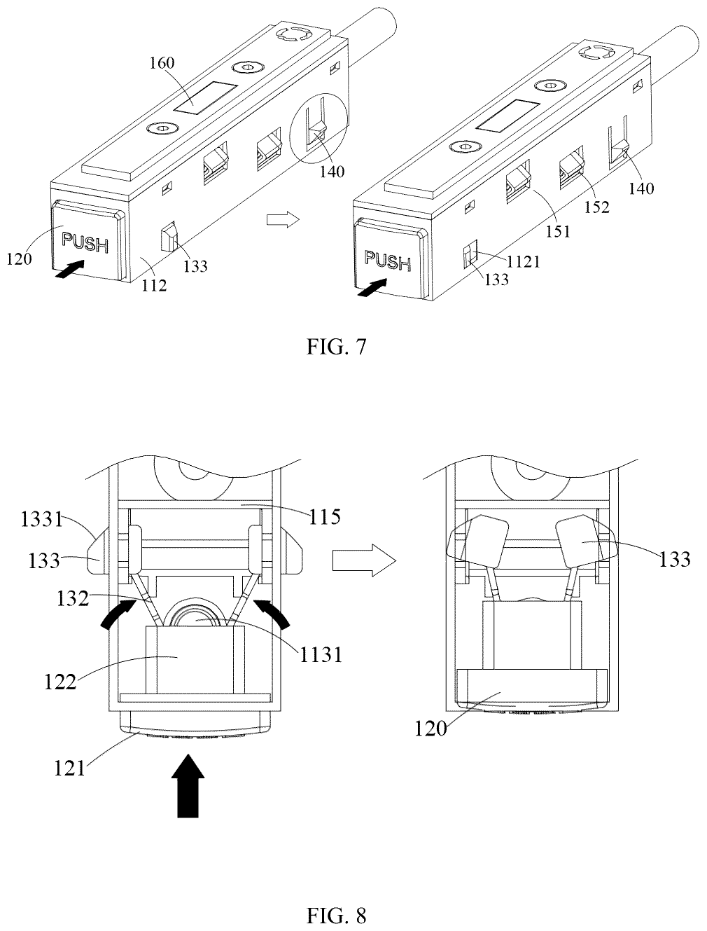

Referring to FIGS. 3 and 4 and with reference to FIGS. 7-8, in an optional example, the top wall 111 and the lower groove are arranged separately. An end of the top wall 111 towards the lower groove extends in a direction towards the lower groove to form a leg 1111. The leg 1111 extends in a direction towards the side wall 112 of the lower groove to form a hook 1112, and the side wall 112 of the lower groove is provided with a clamping opening 1122 in a position corresponding to the hook 1112. The hook 1112 cooperates with the clamping opening 1122 to fixedly connect the top wall 111 to the lower groove. In other examples, the hook 1112 can also be disposed on the lower groove, and the clamping opening 1122 can be disposed on the leg 1111 of the top wall 111. Or, the top wall 111 and the lower groove are fixedly connected in other ways, or the shell 110 can also be integrally disposed, which is not limited in the present disclosure.

The bottom wall 113 of the shell 110 is provided with a fixing part 1131, that is, the fixing part 1131 is disposed at the bottom of the shell 110 and configured to fixedly limit the elastic assembly 130 within the shell 110. In an optional example, the fixing part 1131 is in cylindrical shape and extends in a direction from the bottom wall 113 to the top wall 111 of the shell 110. The elastic body 131 of the elastic assembly 130 is sheathed on the fixing part 1131 to fixedly limit the elastic body 131 within the shell 110, preventing the elastic body 131 from moving left-and-right or front-and-back within the shell 110 driven by the sliding side cover 120 to affect the sliding of the elastic block 133 located on two sides of the elastic body 131 into or out of the elastic block sliding grooves 1121. Further, several booster blocks 1132 are disposed on a peripheral wall of the fixing part 1131 at positions near the bottom wall 113. The booster blocks 1132 are evenly disposed along the peripheral wall of the fixing part 1131, so that the elastic body 131 has a space from the bottom wall 113, and thus the elastic blocks 133 located on two sides of the elastic body 131 have a space from the bottom wall 113, which facilitates the elastic block 133 to slide into or out of the elastic block sliding grooves 1121.

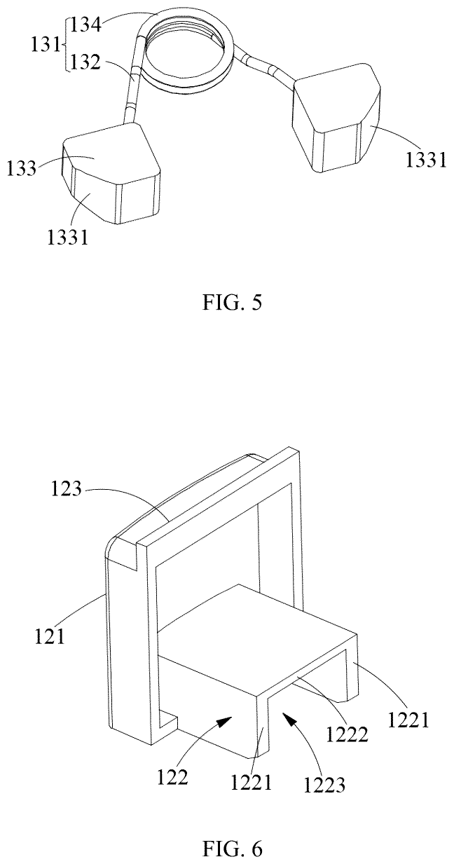

Referring to FIG. 5 and with reference to FIGS. 7-8, the elastic assembly 130 is disposed on the fixing part 1131, and comprises an elastic body 131 and elastic blocks 133 disposed on two sides of the elastic body 131. The elastic body 131 comprises an installation part 134 fixedly connected to the fixing part 1131, and two symmetrically disposed elastic arms 132 inclinedly extending outwards from the installation part. The elastic blocks 133 are disposed at ends of the elastic arms 132 away from the elastic body 131, and integrally formed with the elastic body 131 to save the article quantity and reduce the assembly difficulty.

In an optional example, the elastic body 131 is a torsion spring. The center of the torsion spring, that is, the installation part 134, is annular, the fixing part 1131 is cylindrical, and the installation part 134 is sheathed on the fixing part 1131. The two elastic arms 132 of the torsion spring are symmetrically disposed relative to the fixing part 1131. The elastic blocks 133 are formed on ends of the two elastic arms 132 away from the center of the torsion spring by molding encapsulation process to reduce the article quantity of the elastic assembly 130 and reduce the material and assembly costs. At the same time, using the torsion spring's own properties, the two elastic arms 132 can drive the two elastic blocks 133 located at the ends of the elastic arms 132 to move towards or away from each other. Because the elastic body 131 is fixed on the fixing part 1131, when the elastic arms 132 are pushed by the two support plates 1221 of the sliding side cover 120 in the second direction, the two elastic arms 132 move towards each other, so that the two elastic blocks 133 located at the ends of the two elastic arms 132 away from the elastic body 131 are driven to move towards each other, causing the elastic blocks 133 to slide out of the elastic block sliding grooves 1121. When the push force disappears, the deformation of the two elastic arms 132 automatically recovers. The two support plates 1221 of the sliding side cover 120 are driven by the elastic restoring force of the two elastic arms 132 to move in a direction away from the pushing force, so that the sliding side cover 120 returns to its initial state. At the same time, the two elastic arms 132 thus drive the two elastic blocks 133 located at the ends of the two elastic arms 132 away from the elastic body 131 to move away from each other so that the elastic blocks 133 automatically slide into the elastic block sliding grooves 1121. At the same time, due to the elastic force of the torsion spring, the connection between the elastic blocks 133 and the elastic block sliding grooves 1121 is more stable. In other examples, the elastic assembly 130 can also be other elastic components, or the elastic body 131 and the elastic blocks 133 can be separately provided and then assembled, which is not limited in the present disclosure.

Optionally, the elastic blocks 133 are disposed away from the sliding side cover 120 relative to the elastic body 131, that is, the elastic blocks 133 are disposed away from the sliding side cover 120 relative to the fixing part 1131. When the sliding side cover 120 applies a pushing force to the elastic arms 132 in the second direction, the elastic blocks 133 move towards each other in a direction towards the fixing part 1131. An inclined plane 1331 is disposed on a side of the elastic block 133 near the elastic block sliding groove 1121. The inclined plane 1331 is inclined from an end of the elastic block near the elastic block sliding groove 1121 to an end away from the sliding side cover 120. That is, the inclined plane 1331 is disposed away from the sliding side cover 120. By this arrangement, when the sliding side cover 120 applies a pushing force to the elastic arms 132 in the second direction, the two elastic arms 132 move in a direction towards each other. At that time, a side of the elastic block 133 away from the sliding side cover 120 contacts the elastic block sliding groove 1121. This configuration can facilitate the elastic block 133 to slide out of the elastic block sliding groove 1121 and retract into the installation space 114 of the shell 110. When the push force disappears, the elastic arms 132 move in a direction away from each other under the action of the elastic assembly 130's own elastic restoring force. At that time, the configuration of the inclined plane 1331 can also facilitate the elastic block 133 to slide into the elastic block sliding groove 1121 and to be exposed outside the shell 110, thereby facilitating to abut against the anti-detachment boss 230 on the track 200 to increase the connection stability between the track 200 and the track adapter 100.

Optionally, in the length direction of the shell 110, the length of the elastic block groove 1121 is slightly longer than the length of the elastic block 133 to provide a moving space for the elastic block 133 sliding into or out of the elastic block groove 1121, which facilitates the sliding-in or sliding-out of the elastic block 133.

To facilitate the driving of the elastic block 133 to slide out of or into the elastic block sliding groove 1121, the track adapter 100 of the present disclosure further comprises a sliding side cover 120 slidably connected to an end of the shell 110 and at least partially received within the installation space 114. In other words, the sliding side cover 120 is partially exposed outside the end of the shell 110 to facilitate the applying of the pushing force to the sliding side cover 120. The sliding side cover 120 is slidably connected to the shell 110 in the second direction to drive the elastic arms 132 of the elastic assembly 130 to deform, thereby causing the elastic block 133 to slide into or out of the elastic block sliding groove 1121.

Referring to FIGS. 6-8, the sliding side cover 120 comprises a press part 121 exposed outside the shell 110 and a sliding stop part 122 received within the installation space 114, and a stop wall 123 for limiting the sliding side cover 120 located between the sliding stop part 122 and the press part 121. The press part 121 is exposed outside the shell 110 to facilitate the applying of the pushing force to the sliding side cover 120. The stop wall 123 extends in a direction from the top of the press part 121 towards the top wall 111, and is received within the installation space 114 for limiting the sliding side cover 120, so as to prevent the elastic part 130 from deformation recovery after the pushing force disappears, the sliding side cover 120 is driven by the elastic restoring force of the elastic part 130 to move in a direction away from the elastic part 130 and drops from the end of the shell 110. The sliding stop part 122 is received within the installation space 114, fixedly connected to the press part 121, and disposed near the fixing part 1131 relative to the press part 121, so that the press part 121 drives the sliding stop part 122 to contact the outer surfaces of the two elastic arms 132 of the elastic assembly 130 when the press part 121 is pushed, thereby causing the two elastic arms 132 to deform and drive the elastic blocks 133 to slide out of the elastic block sliding grooves 1121. In this example, the press part 121, the sliding stop part 122 and the stop wall 123 are integrally formed. In other examples, the press part 121 and the sliding stop part 122 can also be provided separately, which is not limited in the present disclosure, as long as the press part 121 and the sliding stop part 122 are fixedly connected and can drive the sliding stop part 122 to move.

The sliding stop part 122 comprises two opposite support plates 1221 and a connection plate 1222 located above the support plates 1221 and configured to connect the support plates 1221. The support plates 1221 and the connection plates 1222 surround to form a receiving groove 1223, and a channel is formed between the two support plates 1221 of the receiving groove 1223, which is used to give way to the fixing part 1131 to prevent the sliding stop part 122 from colliding with the fixing part 1131 and failing to act on the elastic arms 132 of the elastic assembly 130 when the sliding stop part 122 moves towards the fixing part 1131. At the same time, the connection plate 1222 of the receiving groove 1223 can limit the installation part 134 of the elastic assembly 130 in the first direction to prevent the elastic arms 132 of the elastic assembly 130 from being pushed too much to cause the detachment of the installation part 134 from the fixing part 1131. The distance between the two support plates 1221 of the sliding stop part 122 is greater than the width of the fixing part 1131, and less than the distance between the two elastic arms 132 in free state. By this arrangement, the sliding stop part 122 can not only avoid the fixing part 1131, but also interact with the outer surface of the elastic arms 132 of the elastic assembly 130, so that the fixing part 1131 can be received within the receiving groove 1223 during the movement of the sliding stop part 122 towards the elastic assembly 130 to prevent a collision, and meanwhile the elastic assembly 130 is limited in the first direction. The two support plates 1221 of the sliding stop part 122 cooperate with the two elastic arms 132 of the elastic assembly 130 to drive the elastic blocks 133 to slide out or into the elastic block sliding grooves 1121.

When pushed by the sliding side cover 120 in the second direction, the sliding stop part 122 moves in the second direction, and the installation part 134 of the elastic assembly 130 is received in the receiving groove 1223. The two support plates 1221 move in the second direction, and pushes the outer surfaces of the two elastic arms 132, thereby driving the two elastic arms 132 to move towards each other in the third direction, and drive the elastic blocks 133 located at the ends of the elastic arms 132 away from the sliding side cover 120 to move towards each other in the third direction to slide out of the elastic block sliding grooves 1121. At that time, the elastic assembly 130 deforms under the action of the push force. In the first direction, the plane where the lowest point of the connection plate 1222 is located is higher than the plane where the highest point of the fixing part 1131 is located, that is, in the first direction, the connection plate 1222 is located above the fixing part 1131. When the two support plates 1221 cooperate with the two elastic arms 132 to drive the two elastic blocks 133 to slide out of the elastic block sliding grooves 1121, the connection plate 1222 covers above the fixing part 1131 so that the installation part 134 of the elastic part 130 is fixedly limited on the fixing part 1131 to prevent the installation part 134 of the elastic assembly 130 from falling off the fixing part 1131. After the pushing force disappears, under the action of elastic restoring force of the two elastic arms 132, the sliding stop part 122 is driven to move reversely in the second direction.

The two support plates 1221 of the sliding stop part 122 are separated from the two elastic arms 132, and move in a direction away from the pushing force, so that the sliding side cover 120 returns to its initial state. At the same time, the two elastic arms 132 are separated from the two support plates 1221, and the two elastic arms 132 return to their original states and drive the two elastic blocks 133 to slide into the elastic block sliding grooves 1121.

In order to limit the moving distance of the sliding side cover 120 in the second direction within the shell 110, the shell 110 further comprises a limiting rib 115. The limiting rib 115 is configured to limit the moving distance of the sliding side cover 120 in the second direction to prevent the sliding side cover 120 from being pushed too much to completely enter the shell 110, which is not convenient for the restoration and repression of the sliding side cover 120. In addition, the limiting rib 115 is disposed away from the sliding side cover 120 relative to the fixing part 1131 to give a moving distance to the sliding side cover 120, facilitating the contact between the sliding stop part 122 of the sliding side cover 120 and the elastic arms 132 of the elastic assembly 130. In this example, the limiting rib 115 is plate-like, which is disposed at the top wall 111 of the shell 110 and extends from the top wall 111 to the bottom wall 113. In other examples, the limiting rib 115 can also be disposed on the bottom wall 113 and extends in a direction from the bottom wall 113 to the top wall 111, which is not limited in the present disclosure.

Referring to FIGS. 7 and 9 and with reference to FIGS. 10-12, to increase the connection stability between the track adapter 100 and the track 200, the side wall 112 of the shell 110 of the track adapter 100 is further provided with a snap part 140 disposed at an end away from the elastic block sliding grooves 1121. The snap part 140 comprises a fixed end 141 and a free end 142 that are sequentially arranged and connected. A side of the free end 142 away from the fixed end 141 extends in a direction away from the shell 110 to form a stop projection 143. The stop projection 143 is used to stably connect the track adapter 100 to the track 200. The two side walls 112 of the shell 110 are provided with the elastic block sliding grooves 1121 and the snap parts 140. When sliding into the elastic block sliding grooves 1121, the elastic blocks 133 together with the stop projection 143 form four auxiliary support points to secure the track adapter 100 to the track 200. At the same time, the snap part 140 is disposed at an end away from the elastic block sliding grooves 1121 so that the four auxiliary support points are located at four corners of the track adapter 100 to secure the track adapter 100 on the track 200 more firmly. When the external force received by the stop projection 143 reaches a preset threshold, the stop projection 143 disposed on the free end 142 can deform towards the inside of the shell 110 relative to the fixed end 141 to release the connection between the stop projection 143 and the track 200 or facilitate the connection of the stop projection 143 to the anti-detachment boss 230 of the track 200.

The stop projection 143 further comprises a guiding slope 1431 disposed on a side of the stop projection 143 near the fixed end 141. That is, the guiding slope 1431 is disposed on the stop projection 143, and inclinedly extends downwards from the end near the fixed end 141 to the end away from the fixed end 141. By this arrangement, when the track adapter 100 is installed upwards into the track 200 and the stop projection 143 is pressed by the inner surface of the track 200, the guiding slope 1431 can guide the forced direction of the stop projection 143 to facilitate the stop projection 143 to clip into the anti-detachment boss 230 of the track 200.

Further, the stop projection 143 further comprises an abutting slope 1432, which is disposed on a side of the stop projection 143 near the elastic block sliding grooves 1121, and inclinedly extends from the end near the elastic block sliding grooves 1121 to the end away from the elastic block sliding grooves 1121. That is, the abutting slope 1432 is located on the side of the stop projection 143 near the elastic block sliding grooves 1121, and adjacent to the guiding slope 1431. By this arrangement, it facilitates the stop projection 143 to separate from the anti-detachment boss 230 of the track 200 to release the connection between the track adapter 100 and the track 200, thereby facilitating the disassembly of the track adapter 100 from the track 200 (see below for the specific disassembly process).

Further, the track adapter 100 further comprises contact elastic pieces 150, which are disposed within the installation space 114 of the shell 110, and at least partially exposed outside the side wall 112 of the shell 110 to be electrically connected to the conductive part 240 on the track 200 so that the track adapter 100 and the track 200 are electrically connected to each other while mechanically connected to each other.

In an optional example, the contact elastic piece 150 comprises a pair of power supply elastic pieces 151 and a pair of signal elastic pieces 152. Both the power supply elastic pieces 151 and the signal elastic pieces 152 are disposed within the installation space 114 of the shell 110 and exposed outside the side 112 of the shell 110, and the power supply elastic pieces 151 are configured to be in contact fit with the power supply conductive part 241 of the track 200, and the signal elastic pieces 152 are configured to be in contact fit with the signal conductive part 242 of the track 200. In this example, both the pair of power supply elastic pieces 151 and the pair of signal elastic pieces 152 are symmetrically disposed along the central axis in the length direction of the shell 110. That is, one power supply elastic piece 151 and one signal elastic piece 152 are exposed on each side 112 of the shell 110, while the power supply elastic piece 151 and the signal elastic piece 152 are staggered up and down on the same side wall 112 of the shell 110. By this arrangement, it facilitates the electrical connection between the track adapter 100 and the track 200. In other examples, the pair of power supply elastic pieces or the pair of signal elastic pieces 152 can also be disposed on the same side wall 112, which is not limited in the present disclosure.

In another optional example, the contact elastic piece 150 comprises four power supply elastic pieces 151 comprising two positive electrodes and two negative electrodes, and correspondingly, the track 200 comprises four power supply conductive parts 241, so that a dual electrical loop is formed between the adapter 100 and the track 200 to meet the requirement for independently controlling the dual outputs in market-trending dimming and toning products. It can also be made to independently control each loop in a four-wire three-loop circuit, or it can also utilize a combination in which the power elastic pieces 151 are increased or decreased in accordance with the requirement of practical loops.

The power supply elastic pieces 151 and the signal elastic pieces 152 can have certain elasticity. When the power supply elastic piece 151 cooperates by contact with the power supply conductive part 241, the power supply conductive part 241 applies an acting force to the power supply elastic piece 151, and the restoring force of the power supply elastic piece 151 allows the power supply elastic piece 151 to be in contact fit with the power supply conducive part 241 better, thereby achieving a reliable electrical connection. When the signal elastic piece 152 cooperates by contact with the signal conductive part 242, the signal conductive part 242 applies an acting force to the signal elastic piece 152, and the restoring force of the signal elastic piece 152 allows the signal elastic piece 152 to be in contact fit with the signal conductive part 242 better, thereby achieving a reliable signal connection. The power supply elastic piece 151 and the signal elastic piece 152 can have certain elasticity, so that the power supply elastic pieces 151 and the signal elastic pieces 152 are always in contact fit with the power supply conductive part 241 and the signal conductive part 242 of the track 200 when the track adapter 100 slides in the track 200, and will not affect the power supply and signal transmission of the electrical system 300 having the track 200 and the track adapter 100.

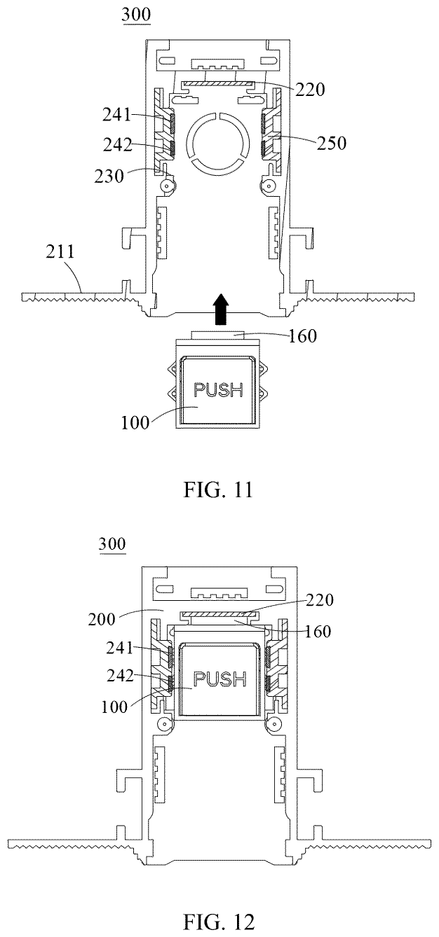

Referring to FIG. 10 and with reference to FIGS. 11-12, the present disclosure also provides a track 200 that is connected and cooperates with the track adapter 100, the track 200 is mechanically connected and electrically connected to the track adapter 100. The track 200 has a receiving space 210, and the track adapter 100 is at least partially located in the receiving space 210 in a first direction and is mechanically and electrically connected to the track 200. The track 200 is fixedly connected to an installation foundation. The track adapter 100 can freely slide along the track 200, so that the installation position of an electrical equipment coupled to the track adapter 100 can be moved on the track 200 as required.

It can be known that the track 200 of the present disclosure can be an embedded track 200, a surface-mounted track 200 or a hanging track 200, which is not limited in the present disclosure. When the track 200 of the present disclosure is an embedded track 200, the lower surface of the track 200 is fixedly connected to the installation foundation. Referring to FIG. 10, the lower surface of the track 200 is provided with an installation plate 211 extending in the width direction and the length direction of the track 200. The installation plate 211 is provided with several installation holes 2111. The quantity of the installation holes 2111 is determined according to the length of the track 200, which is not limited in the present disclosure. The multiple installation holes 2111 are evenly distributed in the length direction of the track 200 for fixing the track 200 onto the installation foundation. Fasteners, such as screws, pass through the installation holes 2111, and the heads of the fasteners are finally pressed on both sides of the installation holes 2111 and locked with the installation foundation, thereby fastening the track 200 to the installation foundation. When the track 200 of the present disclosure is a surface-mounted track 200, the upper surface of the track 200 is fixedly connected to the installation foundation. That is, the upper surface of the track 200 is provided with a receiving space 212 for receiving installation parts (not shown). By the installation parts disposed in the receiving space 212, the track 200 is fixedly installed on the installation foundation. When the track 200 of the present disclosure is a hanging track 200, it is connected to the installation parts in the receiving space 212 of the track 200 through traction structures (not shown), such as hanging wires and rigid suspenders, so that the track 200 is fixed to the installation foundation. The installation foundation in the present disclosure can be a ceiling or a wall, etc.

In an optional example, the track 200 comprises a first magnetic piece 220 disposed at the top of the receiving space 210, and the track adapter 100 comprises a second magnetic piece 160 disposed at the top of the track adapter 100, and the first magnetic piece 220 is in magnetic attraction fit with the second magnetic piece 160 in the first direction to fix the track adapter 100 within the receiving space 210 of the track 200 in the first direction. Specifically, an assembly slot 213 is provided at the top of the receiving space 210 of the track 200, the first magnetic piece 220 is disposed in the assembly slot 213, and the second magnetic piece 160 is disposed at the top wall 111 of the track adapter 100. When the track adapter 100 is installed into the receiving space 210 of the track 200 from the bottom, the first magnetic piece 220 is in magnetic attraction fit with the second magnetic piece 160 in the first direction to connect the track adapter 100 to the track 200, so that the electrical equipment coupled to the track adapter 100 can be installed onto the track 200, and the electrical equipment can slide along with the track adapter 100 on the track 200. It can be known that one of the first magnetic piece 220 and the second magnetic piece 160 can be a permanent magnet, and the other can be an iron piece, and the permanent magnet and the iron piece can be in a magnetic attraction fit. Both of the first magnetic piece 220 and the second magnetic piece 160 can be permanent magnets, and the different magnetic poles of the two permanent magnets can be in magnetic attraction fit with each other. Of course, the first magnetic piece 220 and the second magnetic piece 160 can also be other types of magnetic pieces, which are not specifically limited in the examples of the present disclosure. In this example, the track 200 and the track adapter 100 form a mechanical connection via the magnetic connection. In other examples, the track 200 and the track adapter 100 can also directly form a mechanical connection in a manner, such as clamping or the like, or the track 200 and the track adapter 100 can be both magnetically and mechanically connected, which is not limited in the present disclosure.

In order to further improve the connection stability between the track adapter 100 and the track 200, the track 200 of the present disclosure is further provided with an anti-detachment boss 230 extending in the third direction, which is configured to support the elastic assembly 130 and the snap part 140 of the track adapter 100. The elastic assembly 130, the snap part 140, and the anti-detachment boss 230 are connected to each other and are in an interference fit. By this arrangement, it prevents the track adapter 100 coupled with an electrical equipment from falling off the track 200 when the magnetic attraction between the first magnetic piece 220 and the second magnetic piece 160 disappears or the electrical equipment is relatively heavy. Due to the presence of the elastic assembly 130 and the snap part 140, the connection between the track adapter 100 and the track 200 or the connection between the electrical equipment coupled to the track adapter 100 and the track 200 is more stable, thereby improving the safety of the electrical system 300 having the track 200 and the track adapter 100.

Optionally, the track adapter 100 and the track 200 can also not include other mechanical connection structure, but achieve a mechanical connection only by the elastic assembly 130 and the snap part 140 of the track adapter 100 and the anti-detachment boss 230 of the track 200. Specifically, both side walls 112 of the shell 110 of the track adapter 100 are provided with the elastic block sliding grooves 1121 and the snap part 140 located at two ends of the shell 110. After the track adapter 100 is installed on the track 200, the two elastic blocks 133 slide into the elastic block sliding grooves 1121 to achieve the mechanical connection with the anti-detachment boss 230 of the track 200, and the stop projections 143 are also mechanically connected to the anti-detachment boss 230 of the track 200 by the restoration of deformation. That is, the two elastic blocks 133 and the two stop projections 143 form four stable support points on the anti-detachment boss 230, which can enable the track adapter 100 and the track 200 to be mechanically connected.

Further, the inner surface of the track 200 is provided with a conductive groove 214. A conductive part 240 is disposed in the conductive groove 214 and extends in the length direction of the track 200. A contact surface of the conductive part 240 faces the inside of the track 200, and is used to contact the contact elastic piece 150 of the track adapter 100 to achieve an electric connection with the contact elastic piece 150. When the track adapter 100 is coupled to the track 200 in the first direction, the contact elastic piece 150 located on the outer surface of the track adapter 100 is elastically abutted against the conductive part 240 located on the inner surface of the track, thereby achieving both the mechanical connection and the electrical connection.

Furthermore, the inner surface of the track 200 is further provided with an insulating protective part 250 which extends in the length direction of the track 200. The insulating protective part 250 is wrapped around the outer peripheral wall of the conductive part 240 and is provided with an opening on the side towards the inner surface of the track 200 so that the conductive part 240 can be partially exposed in the conductive groove 214 to be electrically connected to the contact elastic piece 150 on the track adapter 100. The insulating protective part 250 can act as an isolation to prevent short circuit when the track 200 is made of a conductive material. When the track 200 is made of an insulating material, the insulating protective part 250 can also be omitted.

In an optional example, the conductive part 240 comprises a power supply conductive part 241 and a signal conductive part 242, which are both wrapped with insulating protective parts 250 on the outer peripheral walls thereof, and provided with openings on the side towards the inner surface of the track 200 so that the power supply conductive part 241 and the signal conductive part 242 can be partially exposed in the conductive groove 214. The inner surfaces of the two perpendicularly disposed side walls of the track 200 are both provided with two rows of conductive slots 214 in the height direction of the track 200. Two power supply conductive parts 241 and two signal conductive parts 242 are respectively disposed in the four rows of conductive slots 214, and the positions of the power supply conductive parts 241 and the positions of the signal conductive parts 242 correspond to the positions of the power supply elastic pieces 151 and the signal elastic pieces 152 one by one. The power supply conductive parts 241 are used to electrically connect with the power supply elastic pieces 151 of the track adapter 100 to form an electrical loop, and the signal conductive parts 242 are used to electrically connect with the signal elastic pieces 152 of the track adapter 100 to form a control loop, thereby improving the intelligence of the electrical system 300 having the track 200 and the track adapter 100.

In another optional example, the contact elastic piece 150 comprises four power supply elastic pieces 151 comprising two positive electrodes and two negative electrodes, and correspondingly, the track 200 comprises four power supply conductive parts 241, so that a dual electrical loop is formed between the adapter 100 and the track 200 to meet the requirement for independently controlling the dual outputs in market-trending dimming and toning products. It can also be made to independently control each loop in a four-wire three-loop circuit, or it can also utilize a combination in which the power supply elastic pieces 151 or the power supply conductive parts 241 are increased or decreased in accordance with the requirement of practical loops.

Referring to FIGS. 11-12 and with reference to FIGS. 1-10, the present disclosure provides an electrical system 300 that is convenient for rapid installation and disassembly. The electrical system 300 comprises the above-mentioned track 200 and the above-mentioned track adapter 100. The electrical system 300 further comprises an electrical equipment. The electrical equipment is coupled to the track 200 via the track adapter 100, and can slide on the track 200 along with the track adapter 100. The electrical equipment can be an electricity-utilizing equipment, such as lamp and monitoring equipment, or a power supply equipment, such as drive power supply, which is not limited in the present disclosure.

In this example, the track 200 is provided with an anti-detachment boss 230 extending in the third direction. The track adapter 100 comprises a sliding side cover 120, an elastic assembly 130 and a snap part 140. The sliding side cover 120 drives the elastic assembly 130 to be connected to or separated from the anti-detachment boss 230. The snap part 140 is connected to or separated from the anti-detachment boss 230 under the interaction with the inner surface of the track 200 to achieve the mechanical connection between the track adapter 100 and the track 200, or improve the connection stability between the track adapter 100 and the track 200.

In addition, the track 200 is provided with a conductive part 240. The inner surface of the track 200 is provided with a conductive part 240 extending in the length direction of the track 200, and the outer surface of the track adapter 100 is provided with a contact elastic piece 150, the conductive part 240 is electrically connected to the contact elastic piece 150 to achieve the electrical connection between the track adapter 100 and the track 200. An end of the track adapter 100 away from the sliding side cover 120 is provided with a connection part which can be mechanically and electrically connected to the electrical equipment to form an electrical system 300.

The electrical system 300 further comprises a drive power supply, which can be disposed in the installation foundation to provide appropriate power to the track 200 and the electrical system 300 having the track 200 without affecting the aesthetics of the electrical system 300. In other examples, the drive power supply can also be assembled on the track 200 or disposed outside the track 200, which is not limited in the present disclosure.

In an optional example, the electrical equipment is a drive power supply. The drive power supply can also be directly coupled to the track 200, and can be in turn coupled with other electrical equipment, such as illumination lamps, monitoring equipments, intelligent control devices, or sensor modules. At that time, the drive power supply and the track adapter 100 are integrally disposed, that is, the track adapter 100 is provided with the drive power supply to receive power from the electric supply and convert it into power required by other electrical equipment. Or, other electrical equipment, such as illumination lamps, monitoring equipments, intelligent control devices, or sensor modules, can also be equipped with their own drive power sources to achieve power conversion, which is not limited in the present disclosure.

When the track adapter 100 is installed on the track 200 in the first direction, the sliding side cover 120 of the track adapter 100 is pushed in the second direction so that the two support plates 1221 of the sliding stop part 122 of the sliding side cover 120 come into contact with the two elastic arms 132 of the elastic assembly 130 and drive the two elastic arms 132 to move towards each other in the third direction, thereby causing the elastic blocks 133 located at ends of the elastic arms 132 to move towards each other in the third direction to slide out of the elastic block sliding grooves 1121. At that time, the elastic blocks 133 are in the retracted state. The track adapter 100 is pushed into the receiving space 210 of the track 200 in the first direction, and the snap part 140 located on the side wall 112 of the shell 110 of the track adapter 100 is pressed by the inner surface of the track 200, that is, the stop projection 143 of the snap part 140 is guided by the guiding slope 1431 to deform in a direction towards the track adapter 100. After the track adapter 100 is installed in place in the receiving space 210 (e.g., the second magnetic piece 160 located at the top of the track adapter 100 and the first magnetic piece 220 located at the top of the receiving space 210 of the track 200 mutually attract with each other in the first direction), the stop projection 143 of the snap part 140 recovers from deformation, and is connected to the anti-detachment boss 230 of the track 200 in an interference fit. At that time, the sliding side cover 120 is released, under the elastic restoring force of the elastic assembly 130, the two support plates 1221 of the sliding side cover 120 are driven by the elastic restoring force of the two elastic arms 132 to move in the direction away from the pushing force, so that the sliding side cover 120 returns to its initial state. At the same time, the two elastic arms 132 move away from each other in the third direction driven by their own elastic force, and drive the elastic blocks 133 to move away from each other in the third direction to slide into the elastic block grooves 1121 and connect to the anti-detachment boss 230 of the track 200 in an interference fit. At that time, the mechanical installation of the track adapter 100 and the track 200 is completed, while the contact elastic pieces 150 located on the outer surface of the track adapter 100 and the conductive parts 240 located on the inner surface of the track 200 are abutted against each other to form a stable electrical connection.

When it is required to disassemble the track adapter 100 from the track 200, the sliding side cover 120 of the track adapter 100 is applied with a pushing force in the second direction so that the two support plates 1221 of the sliding stop part 122 of the sliding side cover 120 come into contact with the two elastic arms 132 of the elastic assembly 130 and drive the two elastic arms 132 to move towards each other in the third direction, thereby driving the elastic blocks 133 at ends of the elastic arms 132 to move towards each other in the third direction to slide out of the elastic block sliding grooves 1121. At that time, the elastic blocks 133 are in retracted state and separated from the anti-detachment boss 230 of the track 200. The end of the track adapter 100 equipped with the sliding side cover 120 is pulled downwards in the first direction so that the track adapter 100 rotates downwards with the stop projection 143 of the snap part 140 as a center. The side of the stop projection 143 near the elastic block sliding grooves 1121 has an abutting slope 1432. At that time, the abutting slope 1432 comes into contact with the track 200 and is pressed by the inner surface of the track 200, that is, the stop projection 143 of the snap part 140 is guided by the abutting slope 1432 to deform in a direction towards the track adapter 100, and separates from the anti-detachment boss 230 of the track 200, so that the track adapter 100 can be easily removed. At that time, the disassembly of the track adapter 100 from the track 200 is completed.

It can be known that the sliding side cover 120 can be pressed manually to achieve rapid installation and disassembly of the track adapter 100 and the track 200, or the sliding side cover 120 can be automatically pressed by a control device to achieve the rapid installation and disassembly of the track adapter 100 and the track 200, which are not specifically limited in the examples of the present disclosure.

### Example 2

In the Example 2, the structure of the track adapter 100 is substantially the same as that of Example 1 except several details. In this example, only the different parts will be described, and the same parts will not be reiterated.

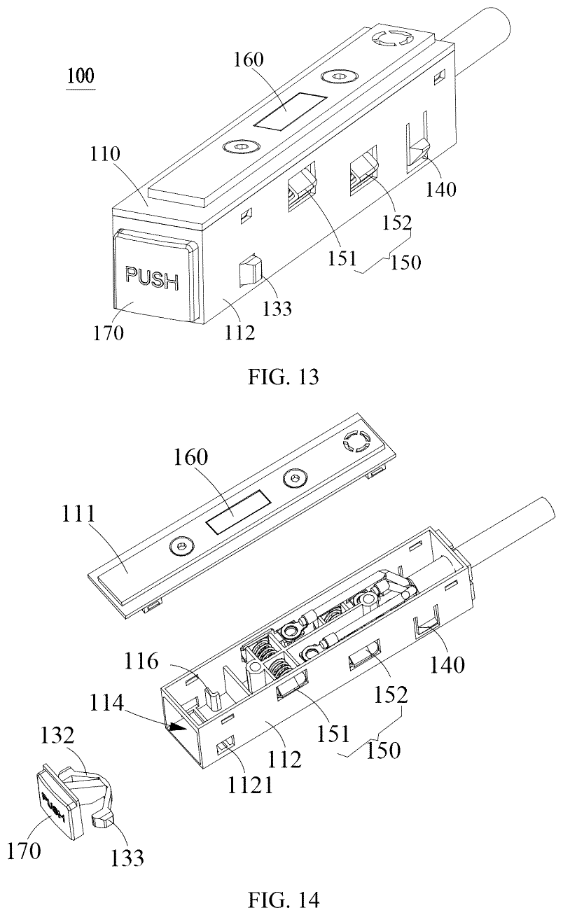

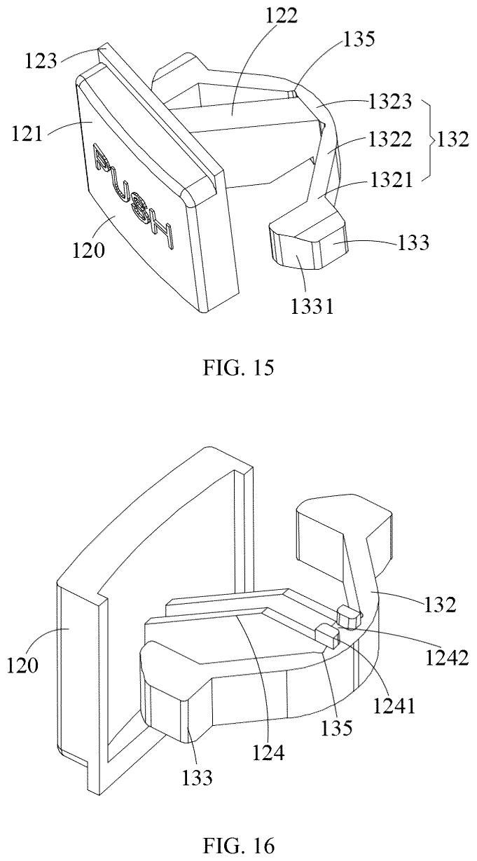

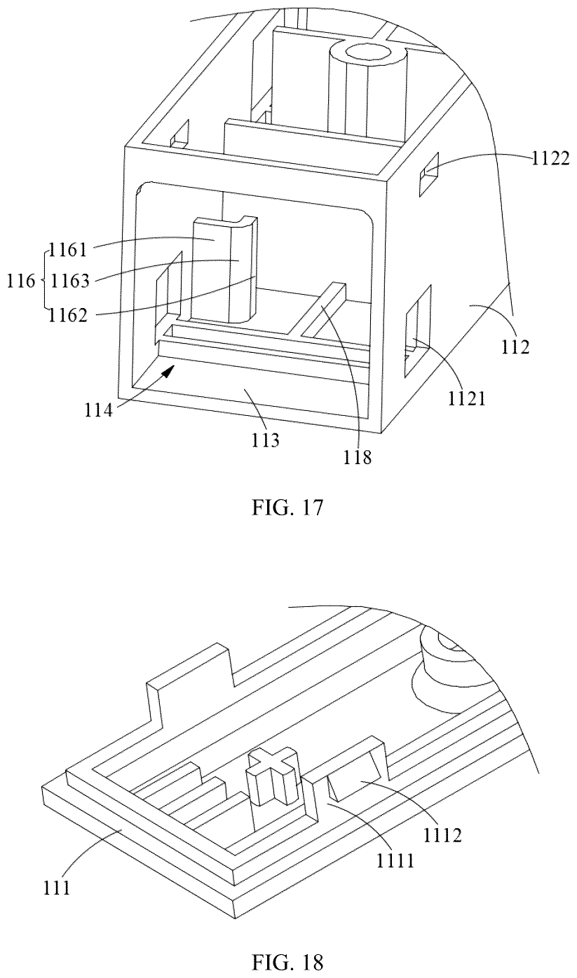

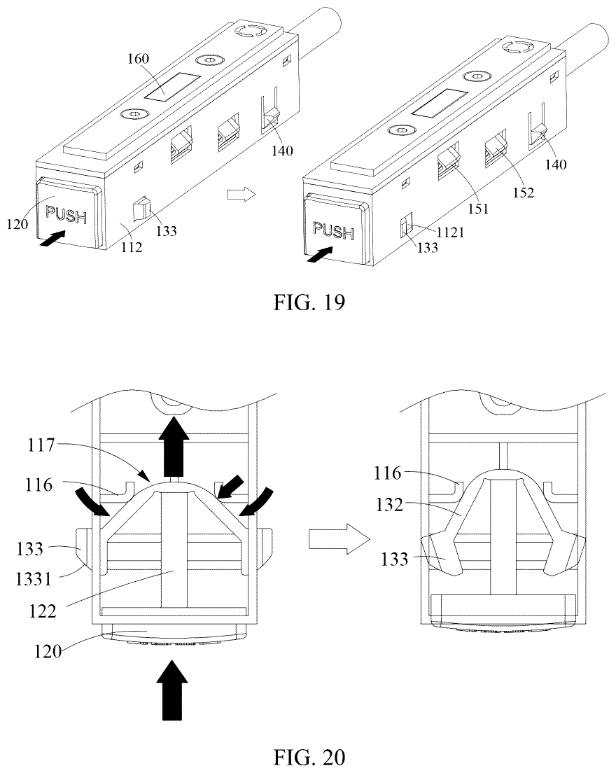

Referring to FIGS. 13-20 and with reference to FIGS. 10-12, a track adapter 100 according to the second example of the present disclosure is shown. The track adapter 100 is configured to couple an electrical equipment to a track 200 in a first direction, and comprises a shell 110 and a sliding assembly 170 slidably connected to the shell 110, and the sliding assembly 170 comprises a sliding side cover 120 located at an end of the shell 110 and an elastic assembly 130 located inside the shell 110 and fixedly connected to the sliding side cover 120. The elastic assembly 130 comprises two symmetrically disposed elastic arms 132 and elastic blocks 133 located at end of each of the elastic arms 132 near the sliding side cover 120. A side wall 112 of the shell 110 is provided with elastic block sliding grooves 1121 at positions corresponding to the elastic blocks 133. Two guide ribs 116 in cooperation with the elastic arms 132 are further disposed inside the shell 110, and a giving-way channel 117 for giving way to the elastic assembly 130 is formed between the two guide ribs 116. The elastic assembly 130 cooperates with the guide ribs 116 to drive the elastic blocks 133 to slide out of or into the elastic block sliding grooves 1121. By this arrangement, it can achieve the rapid installation and disassembly of the track adapter 100 and the track 200, and improve the connection stability of the track adapter 100 and the track 200.

In the Example 2, a first direction, a second direction, and a third direction are involved, which are substantially the same as those in Example 1, and moreover, the structure of the track adapter 100 is substantially the same as that of Example 1 except several details. In this example, only the different parts will be described, and the same parts will not be reiterated.

In this example, the sliding assembly 170 comprises a sliding side cover 120, an elastic assembly 130, and a connection part 124 connecting the sliding side cover 120 and the elastic assembly 130. The sliding side cover 120, the connection part 124, and the elastic assembly 130 are integrally formed. That is, the sliding side cover 120 for pressing and the elastic assembly 130 for elastic deformation is integrally formed via the connection part 124 to reduce the quantity of articles of the track adapter 100, thereby reducing the material and assembly costs. In other examples, the sliding side cover 120, the connection part 124, and the elastic assembly 130 can also be provided separately, which is not limited in the present disclosure.

The sliding side cover 120 is slidably connected to the end of the shell 110, and at least partially received within the installation space to facilitate pushing the sliding side cover 120. The sliding side cover 120 further comprises a press part exposed outside the shell 110 and a stop wall received within the installation space for limiting the sliding side cover 120. The structure and function of the stop wall are the same as those in Example 1 and will not be reiterated here. When the sliding side cover 120 is subjected to a pushing force in the second direction to slide inwards relative to the shell 110, the connection part 124 and the elastic assembly 130 slide inwards together with the sliding side cover 120. The two elastic arms 132 of the elastic assembly 130 come into contact with the two guide ribs 116 disposed within the shell 110 so that the two elastic arms 132 move towards each other, and thus the elastic blocks 133 slide out of the elastic block sliding grooves 1121. When the pushing force disappears, the elastic arms 132 move in a direction away from each other under the elastic force of the elastic assembly 130 itself so that the elastic blocks 133 slide into the elastic block sliding grooves 1121.

The elastic assembly 130 is arranged in U-like shape and comprises two elastic arms 132 symmetrically along the connection part 124 and elastic blocks 133 located at end of each of the elastic arms 132 near the sliding side cover 120. The elastic blocks 133 are disposed near the sliding side cover 120 relative to the elastic arms 132. That is, the U-shaped opening of the elastic assembly 130 faces the sliding side cover 120, and the outer surface of the elastic arms 132 away from the sliding side cover 120 contacts the guide ribs 116 within the shell 110, thereby resulting the occurrence of deformation.

Each elastic arm 132 comprises a first end 1321 away from the sliding side cover 120, a second end 1322 near the sliding side cover 120, and a third end 1323 connecting two second ends 1322 and fixedly connected to the connection part 124. The first end 1321, the second end 1322, and the third end 1323 are integrally formed. The inner side wall of the second end 1322 connected to the third end 1323 is depressed in a direction away from the sliding side cover 120 to form a deformation point 135 to guide the elastic assembly 130 to deform with the deformation point 135 as a designated point so that it can has a controllable motion trail and be more stable after installed onto the track 200.

Further, the distance between the two first ends 1321 is greater than the distance between the two second ends 1322, and the elastic blocks 133 are disposed at the first ends 1321 of the elastic arms 132. By this arrangement, when the pushing force is absent or after the pushing force disappears, the two elastic arms 132 move away from each other in the third direction under the action of their own elastic force, and drive the elastic blocks 133 located at the first ends 1321 of each of the elastic arms 132 to move away from each other in the third direction to slide into the elastic block sliding grooves 1121 and maintain the extended state. In an optional example, the distance between the two elastic arms 132 increases sequentially from the position near the connection part 124 to the position away from the connection part 124. By this arrangement, the two elastic arms 132 in extended state are larger than the width of the shell 110 so that it can spontaneously drive the elastic blocks 133 to slide into the elastic block sliding grooves 1121 and maintain the extended state.

Optionally, the elastic blocks 133 are disposed near the sliding side cover 120 relative to the elastic arms 132. An inclined plane 1331 is disposed on a side of the elastic block 133 near the elastic block sliding groove 1121, and inclined from an end near the elastic block sliding groove 1121 to an end near the sliding side cover 120. That is, the inclined plane 1331 is disposed near the sliding side cover 120. This arrangement is provided, because the U-shaped opening of the elastic arms 132 faces the sliding side cover 120, and the outer surface of the elastic arms 132 away from the sliding side cover 120 contacts the guide ribs 116 within the shell 110. When the sliding side cover 120 applies a pressure to the elastic arms 132, the two elastic arms 132 move towards each other in the third direction. At that time, a sides of the elastic block 133 near the sliding side cover 120 comes into contact with the elastic block sliding groove 1121, and the configuration of the inclined plane 1331 can facilitate the elastic block 133 to slide out of the elastic block sliding groove and retract into the installation space of the shell 110. When the pushing force disappears, the elastic arms 132 move away from each other in the third direction under the action of the elastic force of the elastic assembly 130 itself. At that time, the configuration of the inclined plane 1331 can also facilitate the elastic blocks 133 to slide into the elastic block sliding grooves 1121 and being exposed outside the shell 110.

In this example, the elastic assembly 130 is made of plastic. By the elastic physical properties of the plastics, the elastic arms 132 deform when the elastic arms 132 deform is applied with a pushing force, and the elastic arms 132 automatically recover from the deformation after the pushing force disappears so that the elastic block 133 slide into or out of the elastic block sliding grooves 1121, thereby achieving the rapid installation and disassembly of the track adapter 100. In other examples, the elastic assembly 130 can also be made of other elastic materials, such as elastic metal sheets, which is not limited in the present disclosure.

The connection part 124 is used to connect the elastic assembly 130 and the sliding side cover 120. In an optional example, the connection part 124 is disposed inclinedly, that is, the end of the connection part 124 near the sliding side cover 120 is disposed higher than the end near the elastic assembly 130. This arrangement is provided because the elastic assembly 130 is located below the sliding side cover 120. When the sliding side cover 120 is subjected to a pushing force, the inclinedly disposed connection part 124 facilitates the transmission of the pushing force to the elastic assembly 130. At the same time, the inclinedly disposed connection part 124 improves the structural stability of the sliding assembly 170.

The end of the connection part 124 near the elastic part 130 extends in a direction away from the elastic assembly 130 to form two projecting portions 1241. A guide gap 1242 is formed between the two projecting portions 1241, and the shell 110 is provided with a guide protrusion 118 fitted with the guide gap 1242. The guide protrusion 118 and the guide gap 1242 are used to limit and guide the sliding direction of the sliding assembly 170 within the shell 110.

In this example, the shell 110 is not provided with any limiting rib 115, while two guide ribs 116 in cooperation with the elastic arms 132 of the elastic assembly 130 are provided. A giving-way channel 117 extending in the second direction is formed between the two guide ribs 116. By the giving-way channel 117, the elastic assembly 130 has a movement space to deform when it is pushed by the sliding side cover 120 in the second direction, so that the two elastic arms 132 of the elastic assembly 130 can sufficiently contact and cooperate with the two guide ribs 116. At the same time, it can also limit the sliding distance of the elastic assembly 130 within the shell 110.

Specifically, the two guide ribs 116 are disposed on the bottom wall of the shell 110 in the third direction, respectively, the two guide ribs 116 are disposed near the side wall 112 of the shell 110 and are symmetrically disposed relative to the guide protrusion 118. A giving-way channel 117 is formed between the two guide ribs 116, which is used to give way to the elastic assembly 130 and extend in the second direction. When the sliding side cover 120 pushes the elastic assembly 130 in the second direction, the assembly 130 at least partially enters the giving-way channel 117 in the second direction, while the elastic arms 132 which do not enter the giving-way channel 117 are blocked by the guide ribs 116 to push the elastic arms 132 to move towards each other in the third direction, thereby driving the elastic blocks 133 to slide out of the elastic block sliding grooves 1121 and maintain the retracted state. At that time, due to the blocking of the guide ribs 116, the sliding distance of the sliding assembly 170 within the shell 110 is also limited.

After the pushing force applied by the sliding side cover 120 disappears, the elastic arms 132 move away from each other in the third direction driven by the elastic restoring force, and the elastic assembly 130 is guided by the arc wall 1163 of the guide rib 116 to move out of the giving-way channel 117 in a direction opposite to the pushing force. At the same time, the elastic arms 132 drive the elastic blocks 133 to move away from each other in the third direction to slide into the elastic block sliding grooves 1121 and maintain the extended state.

Each guide rib 116 comprises a first wall 1161 parallel to the sliding side cover 120, a second wall 1162 extending in a direction away from the sliding side cover 120, and an arc wall 1163 connecting the first wall 1161 and the second wall 1162. The arc wall 1163 is in contact with the second end 1322 of the elastic arm 132 at a position near the deformation point 135, and cooperates with the elastic arms 132, so that the two elastic arms 132 move towards or away from each other with the deformation point 135 as the designated movement point. Preferably, the bending direction of the arc wall 1163 is opposite to the bending direction of the elastic arm 132. By this arrangement, when the elastic arms 132 are pushed in the second direction to move into the shell 110, the elastic arms 132 come into contact with the arc wall 1163 at positions near the second wall 1162 to change the pushing direction, so that the vertical pushing force in the second direction is converted into a lateral pushing force in the third direction, which makes it easier for the elastic arms 132 to move towards each other with the deformation point 135 as the rotation point. The elastic assembly 130 partially enters the giving-way channel 117 in the second direction, while the elastic arms 132 drive the elastic blocks 133 to move towards each other in the third direction, so that the elastic blocks 133 slide out of the elastic block sliding grooves 1121. When the pushing force disappears, the elastic arms 132 are driven by their own restoring elastic force to move away from each other in the third direction. The elastic arms 132 come into contact with the arc wall 1163 at positions near the first wall 1161. The first wall 1161 partially converts the lateral pushing force in the third direction into a vertical pushing force in the second direction, so that the elastic assembly 130 is guided by the guide ribs 116 to move out of the giving-way channel 117 in a direction opposite to the pushing direction, which makes the elastic arms 132 easier to return to their initial state and move away from each other in third direction, thereby driving the elastic blocks 133 to move away from each other in the third direction to slide into the elastic block sliding grooves 1121.

In this example, to increase the connection stability between the track adapter 100 and the track 200, the side wall 112 of the shell 110 of the track adapter 100 is further provided with a snap part 140 disposed on an end away from the elastic block sliding grooves 1121. The specific structure of the snap part 140 can be referred to the structure of the snap part 140 in Example 1 of the present utility model, which is not reiterated here.

Similarly, the track adapter 100 in Example 2 further comprises contact elastic pieces 150 configured to be electrically connected with the conductive parts 240 of the track 200. The structure and arrangement of the contact elastic pieces 150 can be referred to those in Example 1, which is not reiterated here.

Referring to FIGS. 10-12 and with reference to FIGS. 13-20, the present disclosure also provides a track 200 which is mechanically and electrically connected to the track adapter 100 of Example 2. The structure of the track 200 can be the same as or different from the track 200 in Example 1, which is not limited in the present disclosure, as long as the track 200 is provided with an anti-detachment boss 230 extending in the third direction, the sliding side cover 120 of the track adapter 100 drives the elastic assembly 130 to cooperate with the guide ribs 116 so that the elastic blocks 133 are connected to or separated from the anti-detachment boss 230; and the snap part 140 is connected to or separated from the anti-detachment boss 230 under the interaction with the inner surface of track 200, which is not limited in the present disclosure or reiterated here.

The present disclosure also provides an electrical system 300 that is convenient for rapid installation and disassembly. The electrical system 300 comprises the above-mentioned track 200 and the above-mentioned track adapter 100. The electrical system 300 further comprises an electrical equipment (not shown). The electrical equipment is coupled to the track 200 via the track adapter 100, and can slide on the track 200 along with the track adapter 100. The electrical equipment can be an electricity-utilizing equipment, such as lamp and monitoring equipment, or a power supply equipment, such as drive power supply, which is not limited in the present disclosure.

Some structures and connection methods of the electrical system 300 in Example 2 are substantially the same as those in Example 1, which are not reiterated here. Only the differences will be described.

When the track adapter 100 is installed on the track 200 in the first direction, the sliding assembly 170 of the track adapter 100 is applied with a pushing force in the second direction so that the sliding side cover 120 drives the elastic assembly 130 to move into the shell 110 in the second direction. The two elastic arms 132 of the elastic assembly 130 come into contact with the two guide ribs 116 within the shell 110, and partially enter the giving-way channel 117. The two guide ribs 116 block the movement of the two elastic arms 132 in the second direction, and convert the pushing force in the second direction into a pushing force in the third direction, so that the two elastic arms 132 move towards to each other in the third direction, thereby causing the elastic blocks 133 located at the first ends 1321 of the elastic arms 132 to move towards each other in the third direction to slide out of the elastic block sliding grooves 1121. At that time, the elastic blocks 133 are in retracted state. The track adapter 100 is pushed into the receiving space 210 of the track 200 in the first direction, and the snap part 140 located on the side wall 112 of the shell 110 of the track adapter 100 is pressed by the inner surface of the track 200, that is, the stop projection 143 of the snap part 140 is guided by the guiding slope 1431 to deform in a direction towards the track adapter 100. After the track adapter 100 is installed in place in the receiving space 210 (e.g., the second magnetic piece 160 located at the top of the track adapter 100 and the first magnetic piece 220 located at the top of the receiving space 210 of the track 200 mutually attract with each other in the first direction), the stop projection 143 of the snap part 140 recovers from deformation, and is connected to the anti-detachment boss 230 of the track 200 in an interference fit. At that time, the sliding side cover 120 is released to remove the pushing force of the sliding side cover 120. The elastic assembly 130 is driven under their own elastic restoring force so that the elastic arms 132 move away from each other in the third direction. The elastic arms 132 come into contact with the arc wall 1163 of the guide ribs 116 at positions near the first wall 1161. The first wall 1161 partially converts the lateral pushing force in the third direction into a vertical pushing force in the second direction so that the elastic assembly 130 is guided by the guide ribs 116 to move out of the giving-way channel 117 in a direction opposite to the push direction, which makes the elastic arms 132 easier to return to their initial state and move away from each other in third direction, thereby driving the elastic blocks 133 to move away from each other in the third direction to slide into the elastic block sliding grooves 1121 to be connected to the anti-detachment boss 230 of the track 200 in an interference fit. At that time, the mechanical installation of the track adapter 100 and the track 200 is completed. At the same time, the contact elastic pieces 150 located on the outer surface of the track adapter 100 and the conductive parts 240 located on the inner surface of the track 200 are in contact with each other to form a stable electrical connection.

When it is required to disassemble the track adapter 100 from the track 200, the sliding assembly 170 of the track adapter 100 is applied with a pushing force in the second direction so that the sliding side cover 120 drives the elastic assembly 130 to move into the shell 110 in the second direction. The two elastic arms 132 of the elastic assembly 130 come into contact with the two guide ribs 116 within the shell 110, and partially enter the giving-way channel 117. The two guide ribs 116 block the movement of the two elastic arms 132 in the second direction, and convert the pushing force in the second direction into a pushing force in the third direction, so that the two elastic arms 132 move towards to each other in the third direction, thereby causing the elastic blocks 133 located at the first ends 1321 of the elastic arms 132 to move towards each other in the third direction to slide out of the elastic block sliding grooves 1121. At that time, the elastic blocks 133 are in retracted state, and separated from the anti-detachment boss 230 of the track 200. The end of the track adapter 100 equipped with the sliding side cover 120 is pulled downwards in the first direction so that the track adapter 100 rotates downwards with the stop projection 143 of the snap part 140 as a center. The side of the stop projection 143 near the elastic block sliding grooves 1121 has an abutting slope 1432. At that time, the abutting slope 1432 comes into contact with the track 200 and is pressed by the inner surface of the track 200, that is, the stop projection 143 of the snap part 140 is guided by the abutting slope 1432 to deform in the direction towards the track adapter 100, and the stop projection 143 of the snap part 140 separates from the anti-detachment boss 230 of the track 200, so that the track adapter 100 can be easily removed. At that time, the disassembly of the track adapter 100 from the track 200 is completed.

It can be known that the press method of the sliding assembly 170 in Example 2 can also be manual or automatic, which is not limited in the present disclosure.

To sum up, by disposing two guide ribs 116 in cooperation with the elastic arms 132 and forming a giving-way channel 117 for giving way to the elastic assembly 130 between the two guide ribs 116, so that, when the elastic assembly 130 moves relative to the guide ribs 116, the guide ribs 116 give a deformation force to the elastic arms 132 to drive the elastic blocks 133 to slide out of or into the elastic block sliding grooves 1211, the track adapter 100 of the present disclosure achieves the rapid installation and disassembly of the track adapter 100 and the track 200 and the connection stability of the track adapter 100 and the track 200 is increased.

An object of the present disclosure is to provide a track adapter which is simple and convenient to install, and has a high stability in connection with the track.

To achieve the above object, the present disclosure provides a track adapter for coupling an electrical equipment to a track in a first direction, comprising: a shell and a sliding assembly slidably connected to the shell, the sliding assembly comprises a sliding side cover located at an end of the shell and an elastic assembly located inside the shell and fixedly connected to the sliding side cover, the elastic assembly comprises two symmetrically disposed elastic arms and elastic blocks located at an end of each of the elastic arms near the sliding side cover, a side wall of the shell is provided with elastic block sliding grooves at positions corresponding to the elastic blocks, two guide ribs in cooperation with the elastic arms are further disposed inside the shell, a giving-way channel for giving way to the elastic assembly is formed between the two guide ribs, and the elastic assembly cooperates with the guide ribs to drive the elastic blocks to slide out of or into the elastic block sliding grooves.

As a further improvement of the present disclosure, the two guide ribs are disposed within the shell in a third direction, respectively, and form the giving-way channel extending in a second direction, the guide ribs cooperate with the elastic arms and are configured so that when the sliding side cover applies a pushing force to the elastic assembly in the second direction, the elastic assembly at least partially enters the giving-way channel in the second direction, while the elastic arms are blocked by the guide ribs and pushed to move towards each other in the third direction to drive the elastic blocks to slide out of the elastic block sliding grooves; and after the pushing force applied by the sliding side cover disappears, the elastic arms are driven by an elastic restoring force to move away from each other in the third direction, and the elastic assembly is guided by the guide ribs to move out of the giving-way channel in a direction opposite to a pushing direction, while the elastic arms drive the elastic blocks to move away from each other in the third direction to slide into the elastic block sliding grooves, and the first direction, the second direction, and the third direction are perpendicular to each other.

As a further improvement of the present disclosure, each of the guide ribs comprises a first wall parallel to the sliding side cover, a second wall extending in a direction away from the sliding side cover, and an arc wall connecting the first wall and the second wall, the arc wall cooperates with the elastic arms so that the two elastic arms are close to or away from each other.

As a further improvement of the present disclosure, the sliding assembly further comprises a connection part connecting the sliding side cover and the elastic assembly, the two elastic arms are symmetrically disposed along the connection part, and each of the elastic arms comprises a first end away from the sliding side cover, a second end near the sliding side cover, and a third end connecting two second ends and fixedly connected to the connection part.

As a further improvement of the present disclosure, an inner side wall of the second end connected to the third end is depressed in a direction away from the sliding side cover to form a deformation point, the deformation point is configured to guide the elastic assembly to deform with the deformation point as a designated point.

As a further improvement of the present disclosure, the elastic blocks are disposed at the first ends of the elastic arms, and a distance between the two first ends is greater than a distance between the two second ends.

As a further improvement of the present disclosure, an end of the connection part near the elastic assembly extends in a direction away from the elastic assembly to form two projecting portion, a guide gap is formed between the two projecting portions, and the shell is provided with a guide protrusion fitted with the guide gap.

As a further improvement of the present disclosure, the sliding side cover, the connection part, and the elastic assembly are formed integrally.

As a further improvement of the present disclosure, a side of the elastic blocks near the elastic block sliding grooves is provided with an inclined plane inclining from an end near the elastic block sliding grooves to an end near the sliding side cover.

As a further improvement of the present disclosure, the side wall is further provided with a snap part disposed at an end away from the elastic block sliding grooves and comprising a fixed end and a free end disposed in turn and connected with each other, a side of the free end away from the fixed end extends in a direction away from the shell to form a stop projection.

As a further improvement of the present disclosure, the stop projection comprises a guiding slope and an abutting slope disposed adjacent to each other, the guiding slope is disposed on a side of the stop projection near the fixed end and inclinedly extends downwards from an end near the fixed end to an end away from the fixed end; and the abutting slope is disposed on a side of the stop projection near the elastic block sliding grooves and inclinedly extends from an end near the elastic block sliding grooves to an end away from the elastic block sliding grooves.

As a further improvement of the present disclosure, the track adapter further comprises contact elastic pieces, the contact elastic pieces are disposed within the shell, at least partially exposed outside the side wall, and configured to be electrically connected to a conductive part within the track.

The second purpose of this disclosure is to provide a track that is connected in conjunction with the aforementioned track adapter.

To achieve the above objective, the present disclosure provides a track, the track is configured to be mechanically and electrically connected to the track adapter above; the track is provided with an anti-detachment boss extending in the third direction, the anti-detachment boss is configured to support the elastic assembly and the snap part of the track adapter.

The third purpose of this disclosure is to provide an electrical system comprising the aforementioned track adapter.

To achieve the above objective, the present disclosure provides an electrical system, comprising a track and the track adapter above; the track is provided with an anti-detachment boss extending in the third direction, the track adapter comprises a sliding assembly, guide ribs, and a snap part, the sliding assembly comprises a sliding side cover and an elastic assembly, the sliding side cover drives the elastic assembly to cooperate with the guide ribs so that the elastic assembly is connected to or separated from the anti-detachment boss; the snap part is connected to or separated from the anti-detachment boss under an interaction between the snap part and an inner surface of the track; the inner surface of the track is provided with an conductive part extending in a length direction of the track, an outer surface of the track adapter is provided with a contact elastic piece, and the conductive part is electrically connected to the contact elastic piece.

As a further improvement of the present disclosure, the track includes a receiving space, the track adapter is at least partially received in the receiving space in the first direction, the track comprises a first magnetic piece disposed at the top of the receiving space, the track adapter comprises a second magnetic piece disposed at the top of the track adapter, and the first magnetic piece is in magnetic attraction fit with the second magnetic piece in the first direction.

The beneficial effects of the present disclosure are: as compared with the prior art, the track adapter of the present disclosure achieves rapid installation and disassembly of the track adapter and the track while the connection stability of the track adapter and the track is increased by disposing two guide ribs in cooperation with the elastic arms and forming a giving-way channel for giving way to the elastic assembly between the two guide ribs so that the guide ribs give a deformation force to the elastic arms when the elastic assembly moves relative to the guide ribs, so as to drive the elastic blocks to slide out of or into the elastic block sliding grooves.

The present disclosure may include dedicated hardware implementations such as disclosure specific integrated circuits, programmable logic arrays and other hardware devices. The hardware implementations can be constructed to implement one or more of the methods described herein.

Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate but not limit the technical solutions of the present disclosure. Although the present disclosure has been described in detail with reference to the examples, one of ordinary skill in the art should understand that modification and equivalent substitution can be made to the technical solutions of the present disclosure without departing from the spirit and scope of the technical solution of the present disclosure.

What is claimed is:

1. A track adapter for coupling an electrical equipment to a track in a first direction, comprising: a shell and a sliding assembly slidably connected to the shell, wherein:
the sliding assembly comprises a sliding side cover located at an end of the shell and an elastic assembly located inside the shell and fixedly connected to the sliding side cover,
the elastic assembly comprises two symmetrically disposed elastic arms and elastic blocks located at end of each of the elastic arms near the sliding side cover,
a side wall of the shell is provided with elastic block sliding grooves at positions corresponding to the elastic blocks,
two guide ribs in cooperation with the elastic arms are further disposed inside the shell,
a giving-way channel for giving way to the elastic assembly is formed between the two guide ribs, and
the elastic assembly cooperates with the guide ribs to drive the elastic blocks to slide out of or into the elastic block sliding grooves.

2. The track adapter according to claim 1, wherein:
the two guide ribs are disposed within the shell in a third direction, and form the giving-way channel extending in a second direction, the guide ribs cooperate with the elastic arms and are configured so that when the sliding side cover applies a pushing force to the elastic assembly in the second direction,
the elastic assembly at least partially enters the giving-way channel in the second direction, while the elastic arms are blocked by the guide ribs and pushed to move towards each other in the third direction to drive the elastic blocks to slide out of the elastic block sliding grooves; and
after the pushing force applied by the sliding side cover disappears, the elastic arms are driven by an elastic restoring force to move away from each other in the third direction, and the elastic assembly is guided by the guide ribs to move out of the giving-way channel in a direction opposite to a pushing direction, while the elastic arms drive the elastic blocks to move away from each other in the third direction to slide into the elastic block sliding grooves, wherein the first direction, the second direction, and the third direction are perpendicular to each other.

3. The track adapter according to claim 1, wherein each of the guide ribs comprises a first wall parallel to the sliding side cover, a second wall extending in a direction away from the sliding side cover, and an arc wall connecting the first wall and the second wall, wherein the arc wall cooperates with the elastic arms so that the two elastic arms are close to or away from each other.

4. The track adapter according to claim 1, wherein the sliding assembly further comprises a connection part connecting the sliding side cover and the elastic assembly, the two elastic arms are symmetrically disposed along the connection part, and each of the elastic arms comprises a first end away from the sliding side cover, a second end near the sliding side cover, and a third end connecting two second ends and fixedly connected to the connection part.

5. The track adapter according to claim 4, wherein an inner side wall of the second end connected to the third end is depressed in a direction away from the sliding side cover to form a deformation point, the deformation point is configured to guide the elastic assembly to deform with the deformation point as a designated point.

6. The track adapter according to claim 4, wherein the elastic blocks are disposed at the first ends of the elastic arms, and a distance between the two first ends is greater than a distance between the two second ends.

7. The track adapter according to claim 4, wherein an end of the connection part near the elastic assembly extends in a direction away from the elastic assembly to form two projecting portion, a guide gap is formed between the two projecting portions, and the shell is provided with a guide protrusion fitted with the guide gap.

8. The track adapter according to claim 4, wherein the sliding side cover, the connection part, and the elastic assembly are formed integrally.

9. The track adapter according to claim 1, wherein a side of the elastic blocks near the elastic block sliding grooves is provided with an inclined plane inclining from an end near the elastic block sliding grooves to an end near the sliding side cover.

10. The track adapter according to claim 1, wherein the side wall is further provided with a snap part disposed at an end away from the elastic block sliding grooves and comprising a fixed end and a free end disposed in turn and connected with each other, wherein a side of the free end away from the fixed end extends in a direction away from the shell to form a stop projection.

11. The track adapter according to claim 10, wherein:
the stop projection comprises a guiding slope and an abutting slope disposed adjacent to each other, wherein the guiding slope is disposed on a side of the stop projection near the fixed end and inclinedly extends downwards from an end near the fixed end to an end away from the fixed end; and
the abutting slope is disposed on a side of the stop projection near the elastic block sliding grooves and inclinedly extends upwards from an end near the elastic block sliding grooves to an end away from the elastic block sliding grooves.

12. The track adapter according to claim 1, wherein the track adapter further comprises contact elastic pieces, the contact elastic pieces are disposed within the shell, at least partially exposed outside the side wall, and configured to be electrically connected to a conductive part within the track.

13. A track, configured to be mechanically and electrically connected to a track adapter, wherein the track adapter is for an electrical equipment to the track in a first direction, and the track adapter comprises a shell and a sliding assembly slidably connected to the shell, wherein:
the sliding assembly comprises a sliding side cover located at an end of the shell and an elastic assembly located inside the shell and fixedly connected to the sliding side cover, the elastic assembly comprises two symmetrically disposed elastic arms and elastic blocks located at end of each of the elastic arms near the sliding side cover, a side wall of the shell is provided with elastic block sliding grooves at positions corresponding to the elastic blocks, two guide ribs in cooperation with the elastic arms are further disposed inside the shell, a giving-way channel for giving way to the elastic assembly is formed between the two guide ribs, and the elastic assembly cooperates with the guide ribs to drive the elastic blocks to slide out of or into the elastic block sliding grooves, and
the track is provided with an anti-detachment boss extending in the third direction, the anti-detachment boss is configured to support the elastic assembly and the snap part of the track adapter.

14. An electrical system, comprising a track and a track adapter, wherein the track adapter is for an electrical equipment to the track in a first direction, and the track adapter comprises a shell and a sliding assembly slidably connected to the shell, wherein:
the sliding assembly comprises a sliding side cover located at an end of the shell and an elastic assembly located inside the shell and fixedly connected to the sliding side cover, the elastic assembly comprises two symmetrically disposed elastic arms and elastic blocks located at end of each of the elastic arms near the sliding side cover, a side wall of the shell is provided with elastic block sliding grooves at positions corresponding to the elastic blocks, two guide ribs in cooperation with the elastic arms are further disposed inside the shell, a giving-way channel for giving way to the elastic assembly is formed between the two guide ribs, and the elastic assembly cooperates with the guide ribs to drive the elastic blocks to slide out of or into the elastic block sliding grooves, and
the track is provided with an anti-detachment boss extending in the third direction, wherein the track adapter comprises a sliding assembly, guide ribs, and a snap part, the sliding assembly comprises a sliding side cover and an elastic assembly, the sliding side cover drives the elastic assembly to cooperate with the guide ribs so that the elastic assembly is connected to or separated from the anti-detachment boss; and
the snap part is connected to or separated from the anti-detachment boss under an interaction between the snap part and an inner surface of the track; the inner surface of the track is provided with an conductive part extending in a length direction of the track, an outer surface of the track adapter is provided with a contact elastic piece, and the conductive part is electrically connected to the contact elastic piece.

15. The electrical system according to claim 14, wherein the track comprises a receiving space, the track adapter is at least partially received in the receiving space in the first direction, the track comprises a first magnetic piece disposed at the top of the receiving space, the track adapter comprises a second magnetic piece disposed at the top of the track adapter, and the first magnetic piece is in magnetic attraction fit with the second magnetic piece in the first direction.
